(19) United States
(12) Patent Application Publication
(10) Pub. No.: US 2011/0276387 A1
(43) Pub. Date: Nov. 10, 2011

(54) VALUATION OF AN ADVERTISEMENT IN A PRINTED ADVERTISING CIRCULAR

(75) Inventors: James P. Rice, JR., Copley, OH (US); Scott T. Whalley, Lake Forest, IL (US)

(73) Assignee: Efficient Collaborative Retail Marketing Company

(21) Appl. No.: 12/914,304

(22) Filed: Oct. 28, 2010

Related U.S. Application Data
(60) Provisional application No. 61/332,393, filed on May 7, 2010.

(51) Int. Cl. G06Q 30/00

(52) U.S. Cl. 705/14.41

(57) ABSTRACT

A method for valuating an advertisement included in a printed advertising circular comprises computing a plurality of scores measuring aspects of the advertisement, and computing a quantitative valuation of the advertisement by computing a weighted aggregation of the scores. At least the computing of the weighted aggregation is performed by a digital processing device. The scores optionally include an advertisement size score. The scores optionally include at least one competition score measuring an aspect of competing advertisements also included in the printed advertising circular. The scores optionally include at least one past history score selected to adjust the quantitative valuation based on past advertising history of a product advertised by the advertisement.

### INCORPORATION BY REFERENCE

This is a non-provisional application which claims the benefit of priority to U.S. Provisional Application Ser. No. 61/332,393, filed May 7, 2010, entitled “Valuation of an Advertisement in a Printed Advertising Circular”, by James P. Rice, Jr., et al., the disclosure of which is hereby incorporated by reference in its entirety.

### BACKGROUND

The following relates to the print advertising arts.

Print advertising typically takes the form of a printed advertising circular, that is, a printed advertisement intended for mass circulation or distribution. Advertising circulars are distributed via distribution pathways including, for example: as newspaper inserts; via mass mailings; as an advertising section or pullout of a magazine; or so forth.

Advertising circulars have been used for a very long time. By way of some illustrative examples, advertising circulars are described in: Homan, U.S. Pat. No. 339,889 issued in 1886; Church, U.S. Pat. No. 372,301 issued in 1887; Baker, U.S. Pat. No. 1,709,831 issued in 1929; and Elkington, GB 467,854 issued in 1937 (Great Britain). Thus, the use of advertising circulars extends back for at least 125 years. In spite of the subsequent development of alternative advertising media such as radio and television, printed advertising circulars remain a popular and effective mode of advertising. Indeed, the printed advertising circular has transitioned to the Internet era, with most retailers providing “on-line” copies of their printed advertising circulars.

Besides low production cost, an advantage of printed advertising circulars is their tangibility and portability as compared with transient ethereal media such as radio or television. Unlike a radio or television advertisement, a consumer can keep his or her advertising circular, mark it up (e.g., circling advertisements of planned purchases using a red pen) and physically take the advertising circular to the retail outlet for reference during shopping. Such advantages are likely to transition effectively to the Internet era, as consumers carry their on-line advertising circulars on their tablet computers, electronic readers (ereaders), or the like and mark up the circulars using styluses operating on touch-sensitive screens.

Another advantage of advertising circulars is that coupons, mail-in rebates, or other incentives can be included in the advertising circular. For example, the consumer can clip out a coupon and turn it in during checkout to obtain a price break or other incentive for purchasing an item. In the case of on-line versions, a coupon bar code shown on the advertisement can be scanned at the checkout line.

In the case of most advertising modalities, such as radio or television, the product supplier controls advertising content and distribution. Thus, the advertising production is limited only by the amount of money the supplier is willing to spend, and perhaps by the total advertising bandwidth of the television service or other advertising medium. In some instances a retailer may produce and its own television or radio advertisement, in which case the retailer has sole control of the content.

The production and distribution of printed advertising circulars are somewhat unusual in that it is typically a “collaboration” between the supplier and the retailer. The advertising circular is produced and distributed by the retailer, who in most cases carries a wide range of products including products by different suppliers in direct competition. For example, a single retailer may carry a number of different shampoo products manufactured or provided by different suppliers. For a given product (e.g., a given brand of shampoo), its advertising in the retailer's advertising circulars is determined by agreement between the supplier and the retailer, sometimes as part of an overall agreement covering various aspects of merchandising of the product by the retailer. To encourage purchase of the given product as opposed to competing products also carried by the retailer, the supplier wishes for its product to be given prime placement in the advertising circular. The supplier may also take other measures to promote its product, such as providing incentives such as coupons. It is also know that the supplier may provide other incentives that may or may not be found directly on the advertisement, such as customer rewards, loyalty point, etc.

The retailer has its own interests in product placement, which may differ from those of the supplier. For example, if the supplier's product is not selling well, then the retailer may prefer to more strongly promote better-selling competing products. Other factors such as the retailer's profit margin may impact is interests in the product placement. A further complication is that some retailers market “private label” products which are sold under the retailer's brand. Since the retailer usually make more money per sale on a private label branded product as compared with a comparable product sold under a supplier's brand, the retailer has interest in promoting its private label branded products.

In view of the foregoing, the “collaboration” between supplier and retailer is more of an arm's length negotiation, in which the supplier usually provides inducement (monetary or otherwise) to the retailer in order to obtain favored placement of the supplier's products in the circular. This quasi-adversarial relationship between supplier and retailer has developed over a long period of time, and conventions have been established for this negotiation. Conventionally, a contract between the supplier and retailer in the form of a “deal sheet” or other written agreement is drawn up. In the agreement, advertising circular space is graded on an “A”, “B”, or “C” scale. The highest grade, “A”, indicates that the supplier's product is advertised on the front or back cover of the advertising circular (these are the most prominent pages) with an illustration of the product shown. The intermediate grade “B” indicates that an illustration of the supplier's product is shown on an inside page of the circular. The lowest grade “C” indicates the product is not illustrated, but only verbally listed. Such printed advertisement grading systems are used, for example, by The Nielsen Company (New York, New York, USA) and Information Resources, Inc. (IRI, Chicago, Ill., USA).

### BRIEF SUMMARY

In some embodiments disclosed herein as illustrative examples, a method comprises: computing a plurality of scores measuring aspects of an advertisement included in a printed advertising circular; and computing a quantitative valuation of the advertisement by computing a weighted aggregation of the scores; wherein at least the computing of the weighted aggregation is performed by a digital processing device.

In some embodiments disclosed herein as illustrative examples, an apparatus comprises: a digital processing device configured to perform a method comprising computing a plurality of scores measuring aspects of an advertisement included in a printed advertising circular and computing a quantitative valuation of the advertisement by computing a weighted aggregation of the scores; and a display device for displaying a visual representation of the quantitative valuation.

In some embodiments disclosed herein as illustrative examples, a storage medium stores instructions executable by a digital processor to perform a method including (i) computing a plurality of scores measuring aspects of an advertisement included in a printed advertising circular and (ii) computing a quantitative valuation of the advertisement by computing a weighted aggregation of the scores.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows an advertisement valuation system.

FIG. 2 diagrammatically shows an embodiment of the scoring/valuation module of the advertisement valuation system of FIG. 1.

FIGS. 3 and 4 diagrammatically show illustrative advertising circular pages that show an advertisement having a low valuation (FIG. 3) and having a high valuation (FIG. 4) as computed by the valuation system of FIG. 1.

### DETAILED DESCRIPTION OF PREFERRED EMBODIMENTS

The following relates to advertising circulars. As used herein, the term “printed advertising circular” encompasses a conventional print version of an advertising circular, and also any on-line version of the printed advertising circular that may be available on the retailer's website or elsewhere. The on-line version of the printed advertising circular may include additional features not present in the conventional print version, such a hyperlinks from advertisements to pop-up windows providing additional details of the advertised product or so forth.

The conventional “A”, “B”, “C” grading scale for advertisements is convenient and widely used. However, it is recognized herein that this grading scale places suppliers at a disadvantage in negotiations with retailers. The inventors have analyzed correlations of actual sales as compared with advertisement grades, and have found that in practice advertisement impact on sales is poorly predicted by the advertisement grade. For example, the “B” grade encompasses a very wide range of advertisement space, including some very effective advertisements and substantially ineffective advertisements.

A supplier would like to be able to perform advertisement valuation in a way that correlates with actual sales on a nearly real-time basis, or (more practically) with a short time lag, e.g. less than one week. However, the supplier does not have actual sales information until typically about four weeks after the advertisement circular is distributed. Moreover, deal sheets are often drawn up on a quarterly basis or even longer time period basis, which limits supplier's short-term options for enhancing sales. Thus, even if the supplier had feedback with time lag of less than one week, this might be insufficient to correct negative sales performance.

Disclosed herein are improved advertisement scoring approaches, which provide advertisement valuation that correlates with actual sales. Accordingly, the disclosed valuation techniques can be used for applications such as optimizing advertisement placements (for example, as embodied by terms set forth in a deal sheet between the supplier and a retailer), and assessing effectiveness of advertising pathways. For the latter application, the disclosed advertisement valuation techniques enable the analysis to separate between (1) advertisement properties affecting the effectiveness of the advertisement, and (2) effectiveness of the advertising pathway (e.g., the retailer chosen for distributing the product). The disclosed advertisement valuation techniques are also expected to find application by retailers, for example in designing advertisement circulars to maximize effectiveness of product placements.

The disclosed advertisement valuation depends on advertisement scores that measure the quality of the current advertisement considered alone, i.e. “in a vacuum”. The advertisement scores measure advertisement placement and size in the advertising circular, along with any auxiliary support that may be provided by incentives specified in the advertising circular or a free-standing insert (FSI) that may be included in the advertising circular.

It is to be understood, as used in this discussion incentive(s) is/are understood to include incentive(s) from the supplier and/or retailer found in the advertisement (e.g., coupons, two for one deals, etc.) or ones that may be separate from the advertisement (e.g., customer rewards or loyalty points, etc.). In the following discussion such inventive(s) may be one of the above or combinations thereof.

Additionally, the disclosed advertisement valuation depends on competition scores that measure quality of advertisements of competing products in the same advertising circular. The inventors have found that accounting for these competing advertisements substantially enhances correlation with actual sales as compared with valuation that considers the supplier's advertisement in a vacuum. For example, a given advertisement may be effective generally, but may be much less effective if it is placed next to a larger advertisement for a competing product in the same circular.

Still further, the disclosed advertisement valuation depends on past advertising history of the supplier's product. The inventors have found that the past advertising history can substantially affect the value of the current advertisement. For example, an advertisement that ordinarily would be effective might be less effective if it is run in an advertising circular immediately after a previous bulk quantity offer (e.g., a “10 packs for $10” offer).

Advantageously, the advertisement scores and the advertising history scores can be determined before an advertisement is run (that is, before the advertising circular containing the advertisement is distributed), based on information entirely available to the supplier. The competition scores typically become ascertainable once the advertising circular is finalized, since the competition scores depend upon the placement of advertisements of competing products. However, the competition scores can advantageously be determined entirely based on the advertising circular, without reference to other information that may be controlled by the retailer or by the competing suppliers. Moreover, based on the disclosed valuation approaches, the supplier may choose to construct its deal sheet with the retailer including specifications on competing advertisements guided by disclosed competition scoring.

The disclosed advertising valuation employs a weighted sum of the advertisement scores. Advantageously, this enables tailoring or adjustment of the impact of the various scores on the overall advertisement valuation. Such tailoring or adjustment may be applied based on the product type, the level of competition, and so forth. Moreover, in situations in which certain scores are unavailable (for example, prospective valuation of an upcoming advertisement for which the competition scores are not available) it is straightforward to compute valuation without the unavailable scores through suitable adjustment of the weightings, with the unavailable scores assigned zero weightings so as to remove them from the valuation.

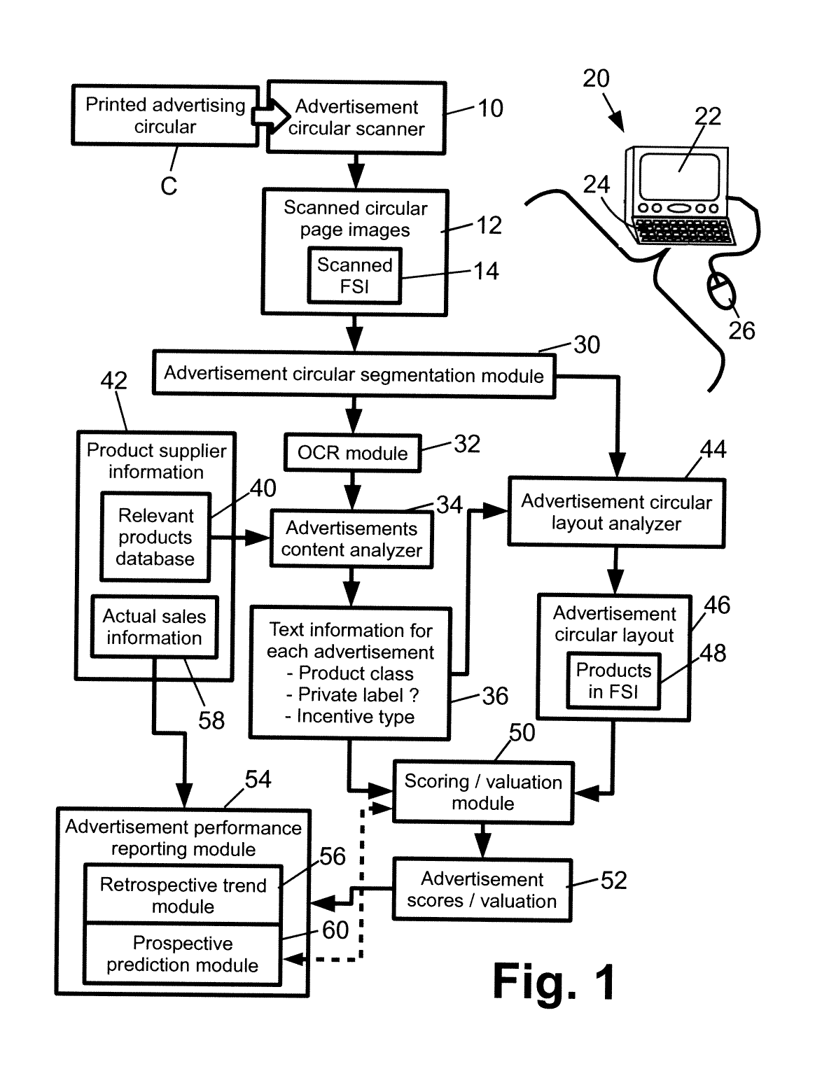

With reference to FIG. 1, an illustrative advertisement valuation system is described. The system is described as it might be used by a supplier who wants to perform valuation of its advertisement in an advertising circular C. The illustrative advertising circular C is in printed form, and is optically scanned by an advertisement circular scanner 10 to generate a set of scanned circular page images 12. The scanner 10 may, for example, be embodied by a copy machine or other conventional office equipment having optical scanning capability, although a dedicated advertising circular scanning device is also contemplated. In some embodiments, the advertising circular C may have as few as a single page. In some embodiments, the advertising circular C may have multiple pages and also may include a free-standing insert (FSI) 14. The FSI 14, if included, is provided by the retailer (or other circular producer) to highlight certain items for aggressive advertising.

In the illustrative embodiment of FIG. 1 the advertising circular C is in printed form and is converted to page images 12 by the scanner 10; however, it is also contemplated for the advertising circular to be in electronic form, for example as an on-line copy of the advertising circular available at the retailer's website. In such cases the scanner 10 is suitably omitted, or optionally replaced by a data processing module (not shown) that converts the on-line circular to a desired format.

The remainder of the advertisement valuation system is suitably embodied as a digital processing device, such as an illustrative computer 20, executing suitable software, firmware, or other instructions. The digital processing device includes suitable user interfacing components—in the case of the illustrative computer 20, these include an illustrative display device 22 providing visual output (and, if embodied as a “touch screen”, optionally also providing for user input), an illustrative keyboard 24, and an illustrative mouse 26 (or a trackball, track pad, or other pointing device). Instead of the illustrative computer 20, the advertising valuation system can be embodied by another digital processing device such as a network server, a personal data assistant (PDA), a laptop or notebook computer, a tablet device such as an iPad (available from Apple Corporation, Cupertino, Calif., USA), or so forth. In a portable system such as a valuation system on a notebook computer or iPad platform, wireless Internet connectivity is suitably used to download the on-line circular in a format such as portable document format (PDF) to generate the page images 12. In a desktop embodiment, the illustrative computer 20 is operatively connected with the optical scanner 10 via a suitable cable or via a wired, wireless, or hybrid digital network such as a WiFi and/or Ethernet network to acquire the page images 12 from the illustrative printed advertising circular C. These are merely illustrative examples.

It is also to be appreciated that the advertisement valuation system may be embodied by a storage medium storing instructions executable by a digital processing device to implement the valuation system. By way of illustrative example, the storage medium may be a hard disk (not shown) of the computer 20 or some other magnetic storage medium, or an optical disk or other optical storage medium, or random access memory (RAM, not illustrated) of the computer 20 or FLASH memory or some other electronic storage medium, or so forth.

With continuing reference to FIG. 1, an advertisement circular segmentation module 30 processes the set of circular page images 12 to identify individual advertisements. The advertisement circular segmentation module 30 may operate automatically, semi-automatically, or manually. In a manual approach, a human user delineates individual advertisements by bounding boxes (or, more generally, closed bounding curves), for example by using the mouse 26 or another pointing-type input device. In an automatic approach, a suitable segmentation algorithm is employed to identify advertisements, for example as disclosed in Deng et al., WO 2008/034001 A1 titled “Methods and Apparatus to Identify Images in Print Advertisement” which is incorporated herein by reference in its entirety. In some suitable semi-automatic approaches, tan automatic segmentation algorithm is executed to generate proposed advertisement delineations as bounding boxes or the like, and these proposed delineations may be manually adjusted, deleted, or added to via the mouse 26 or other pointing device.

Once the various individual advertisements are delineated, an optical character recognition (OCR) module 32 is suitably applied to each individual advertisement in order to detect and represent textual content, for example as ASCII strings. Substantially any OCR algorithm or program can be employed. The OCR may execute on the digital processing device 20, or in some embodiments the scanning device 10 may include integral OCR processing to perform this task. The OCR'd text is analyzed by an advertisements content analyzer 34 to extract text information 36 for each advertisement, such as brand name (including private label brand names), product type (e.g., “toothpaste”, or “pain killer”, or “aspirin”, or so forth), incentive-indicative text (for example, text such as “off” as in “$2 off”, or “buy one get one free” or so forth), or so forth. The content analyzer 34 references one or more suitable databases, such as an illustrative relevant products database 40 which is suitably provided to the advertisement valuation system as part (or all) of a collection of product supplier information 42. By referencing such a database 40, the content analyzer 34 can associate textual content of the advertisement with a known brand name as identified in the database 40. Similarly, the content analyzer 34 can associate textual content of the advertisement with a known product type as again identified in the database 40. In this way, the extracted text information for each advertisement includes relevant information such as brand name, an indication of whether the brand name is a private label, a product type, an incentive type (which may be “no incentive” or the like in some instances), and so forth.

Although automated operation of the textual content analyzer 34 is described, it is also contemplated for the textual content analyzer 34 to operate manually or semi-automatically. In a suitable manual operation, the content analyzer 34 displays a segmented advertisement on the display device 22 as an image, together with a set of input fields for relevant information such as brand, product type, incentives, or so forth. The user then inputs this information using available input devices 24, 26. In a suitable semi-automatic approach, the described automatic processing is performed to populate the input fields with proposed values which can be corrected as appropriate by the human user using the available input devices 24, 26.

An advertisement circular layout analyzer 44 analyzes the advertising circular as a whole in order to determine an advertising circular layout 46, which is defined as information relating to the positions, sizes, pages, or other geometrical aspects of the advertisements. For example, the layout analyzer 44 may identify for each advertisement at least its size (suitably quantified by an area, or by a height value and a width value, or so forth) and the page on which it appears. Additionally, the layout analyzer 44 may identify further information such as the neighboring advertisements that are proximate to each individual advertisement. If the page images 12 include the illustrative scanned (or downloaded) free-standing insert (FSI) image 14, then the layout analyzer may identify for each advertisement whether it appears in the FSI, so as to compile a list of products in the FSI 48 as part of the layout information 46. In the illustrative embodiment, the advertisement circular layout analyzer 44 receives the text information 36 for each advertisement and thereby can identify any duplicate advertisements (for example, in some instances the same product may appear on both the front page of the circular and at an inside page of the circular, or the same product may appear both in the circular and in the FSI). Again, although automated processing is described, it is also contemplated for the layout analyzer 44 to operate in a semi-automatic or manual mode. If the layout information is limited to advertisement size and the page of the circular at which the advertisement appears, then it is also contemplated for the layout analyzer 44 to be integrated with the segmentation module 30, since the segmentation processing identifies the advertisement space (from which the size is readily computed) and page.

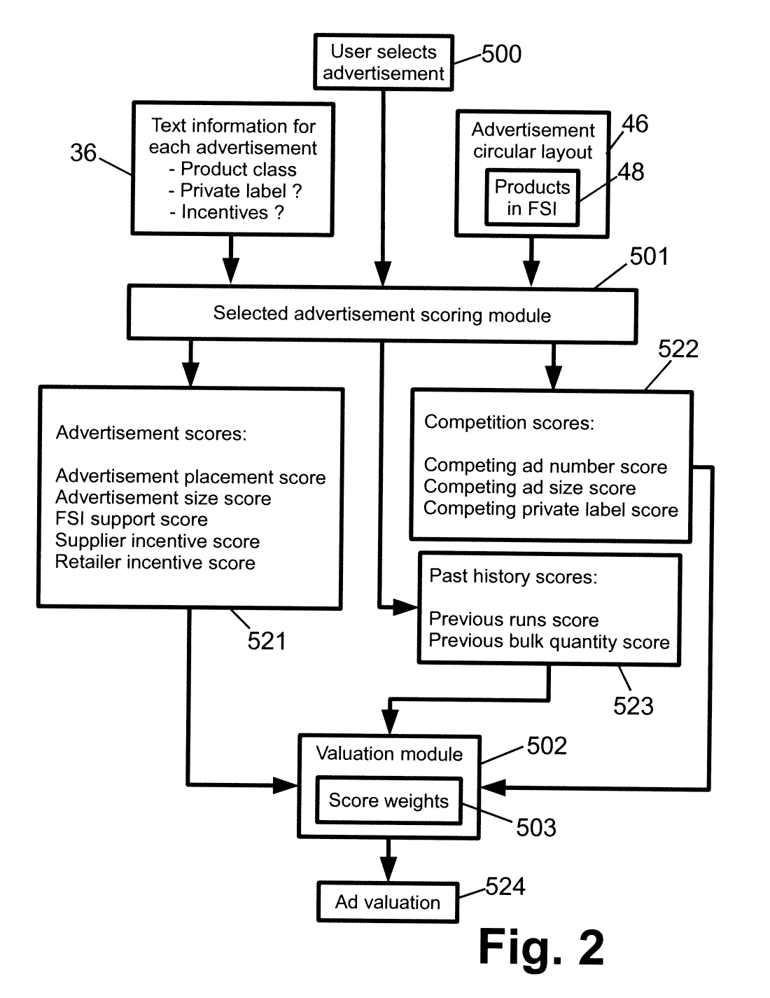

The output 36, 46, 48 of the various analysis components 32, 34, 44 serves as input to a scoring/valuation module 50 which computes advertisement scores and an overall advertisement valuation 52 for an advertisement of interest such as the supplier's advertisement in the advertising circular C. The scores include advertisement scores that measure features of the supplier's advertisement that tend to increase or discount the value of the supplier's advertisement. The scores optionally also include competitor scores that measure features of competitors' advertisements in the advertising circular C that tend to increase or discount the value of the supplier's advertisement. The scores optionally also include past advertising history scores respective to the supplier's advertisement that tend to increase or discount the value of the supplier's advertisement. The overall valuation is a weighted aggregation of the scores. Operation of the scoring/valuation module 50 is described herein in greater detail with reference to FIG. 2.

With continuing reference to FIG. 1, the advertisement scores/valuation 52 serve as input to an advertisement performance reporting module 54. The reporting module 52 may suitably report the scores and/or the overall valuation as quantitative values, for example displayed as numeric values or using a bar chart or other graphical representation. Optionally, the reporting module 54 may bin the valuation in order to simplify interpretation. In one illustrative example, three bins are employed corresponding to poor quality, competitive quality, and superior quality advertisement valuations. In this example if the supplier's advertisement has a score of less than or equal to V_{th,poor} then it is suitably binned as a “poor quality” advertisement; if the supplier's advertisement has a score of greater than V_{th,poor} and less than V_{th,superior} then it is suitably binned as a “competitive quality” advertisement: and if the supplier's advertisement has a score of greater than or equal to V_{th,superior} then it is suitably binned as a “superior quality” advertisement. More or fewer bins can be added to provide less or greater “resolution” to the advertisement valuation and the bins can be variously “named” to provide a semantically meaningful valuation.

In one embodiment, determining to which bin an advertisement is provided is accomplished by scoring all of the advertisements in a selected group, and obtaining the mean score of the group. Thereafter a positive first standard deviation is applied to the mean score and advertisements which have a score equal to or greater than this “positive” score are rated as “superior quality”; in the same manner a negative first standard deviation is applied to the mean and advertisements having this “negative” score or lower are rated as “poor quality”; finally those advertisements between the “positive” score and the “negative” score are identified as being of a “competitive quality”.

The illustrative advertisement performance reporting module 54 includes additional components for providing additional functionality. An illustrative retrospective trend module 56 enables plotting of valuations (or scores) as a function of circular distribution date. For example, considering an advertisement circular that runs weekly, the retrospective trend module 56 suitably plots advertisement valuation for each week. Optionally, the retrospective trend module 56 superimposes or otherwise fuses actual sales information 58 (optionally provided as part of the product supplier information 42 provided to the valuation system) on the plot of advertisement valuation versus distribution date.

The illustrative advertisement performance reporting module 54 also includes an illustrative prospective prediction module 60 that predicts a valuation for a contemplated future advertisement. In a suitable embodiment of the prospective prediction module 60, the user is presented with an input dialog screen via which the user can input information corresponding to or from which the various scores can be determined. For example, the user may input advertisement size, incentives, past advertisement history information, or so forth. The prospective prediction module 60 then invokes the advertisement scores/valuation module 50 (diagrammatically indicated in FIG. 1 by a double-headed broken connecting line) to compute scores and valuation for the contemplated future advertisement. By manual iteration, the user can adjust the advertisement parameters to optimize the valuation.

With reference to FIG. 2, operation of the advertisement scores/valuation module 50 is described in greater detail. An advertisement is selected for scoring/valuation in an operation 500. The selection operation 500 may be performed automatically, semi-automatically, or manually. By way of illustrative example, an automatic selection may entail selecting the advertising having a specified brand name corresponding to the supplier who is employing the valuation system. In an illustrative manual selection, the user selects an advertisement of interest from the set of segmented advertisements using the user interfacing components 22, 24, 26 (see FIG. 1), for example by having the display 22 show thumbnail images of the advertisements and having the user employ the pointing device 26 to select the selected advertisement. In the following, the selected advertisement is assumed to be the supplier's advertisement—however, more generally the supplier might also want to select a competitor's advertisement for valuation to see how the supplier's advertisement value compares with the value of a competitor's advertisement.

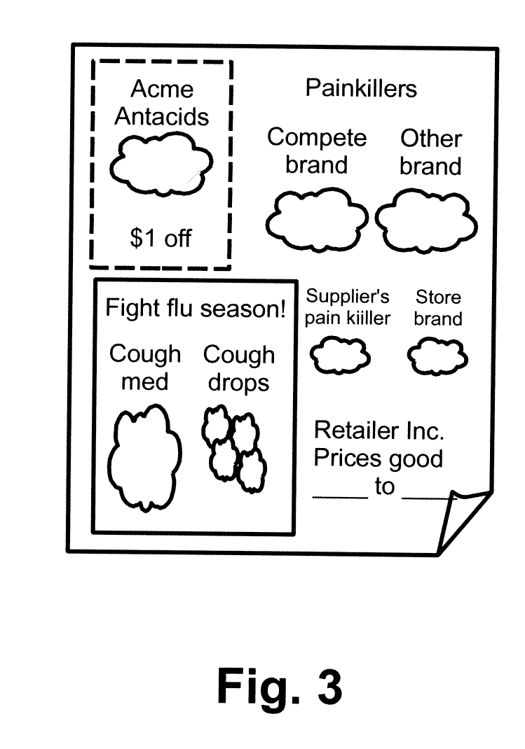

In illustrative FIG. 2, the advertisement scores/valuation module 50 is represented as two components: a selected advertisement scoring module 501; and a valuation module 502. As the valuation employs a weighted aggregation of the scores, the valuation module 502 includes or has access to a set of score weights 503 for weighting the various scores. The advertisement scores/valuation output 52 is shown in FIG. 3 as three sets of scores, namely advertisement scores 521, competition scores 522, and past history scores 523, and an advertisement valuation 524.

The scoring module 501 computes various scores that measure aspects of the advertisement (namely advertising scores 521), that measure aspects of competitors' advertisements (namely competitor's scores 522), and that measure aspects of the past advertising history for the product that is the subject of the selected advertisement (this is the past history scores 523). Each of these score sets is addressed in turn. In the following examples, each score is assumed to have a maximum value of “1”. This is merely an illustrative example, and in general the scoring scales can have various ranges. In some embodiments it is contemplated for a score to have a negative value indicating a “devaluing” of the advertisement on that scoring basis. In other embodiments (as another illustrative example) each score may be constrained to lie in a range [0,1].

The advertising scores 521 are computed based on the selected advertisement alone, without reference to other advertisements in the advertising circular. However, it is to be understood that the advertising scores 521 may include measures that depend on the placement of the selected advertisement in the circular. In the illustrative example, the advertising scores set 521 include the following five scores: an advertisement placement score; an advertisement size score; a free-standing insert (FSI) support score; a supplier incentive score; and a retailer incentive score. These are addressed in turn.

The advertisement placement score is computed based on the position of the supplier's (i.e., selected) advertisement in the advertising circular. The advertisement placement score can be variously computed. In one approach, it is based solely on the page on which the advertisement appears. For example, in one such approach appearance on the front or back cover of the advertising circular provides a placement score of “1”, while appearance inside the circular provides a lower placement score (e.g., “0.5”, or “0”). Optionally, the placement score can also incorporate information on whether the advertisement includes an illustration. In one such example, the advertisement placement score parallels the conventional “A”, “B”, “C” grading approach, with an advertisement of grade “A” (front or back cover with illustration) scoring “1”, an advertisement of grade “B” (inside circular with illustration) scoring a lower value such as “0.5”, and an advertisement of grade “C” (inside circular without illustration) scoring a still lower value such as “0”.

The advertisement size score is generally expected to scale with the size of the advertisement, reflecting the expectation that (all else being equal) a larger advertisement is likely to be more effective than a smaller advertisement. In the illustrative example, the advertising size score is constrained to be less than or equal to 1. In some embodiments the advertisement size score is a continuous value in a range [0,1]. In other embodiments, the advertisement size score is a binned value, for example taking on the closest discrete bin value to the actual advertisement size selected from a set of bins {0.2, 0.4, 0.6, 0.8, 1.0}. Other quantifications of the advertisement size score are also contemplated.

The FSI support score is suitably a binary score value which is weighted in its use: for example a value of “1” indicates the supplier's advertisement is in the FSI or includes a reference in the FSI, while a value of “0” indicates the supplier's advertisement is not in the FSI and is not referenced in the FSI. The score is weighed in that in one embodiment the score is time related, wherein information from an immediately past week, has a different weighting from the week before and so on.

The supplier incentive score indicates whether (and optionally how) the supplier incentivizes purchasing the product that is the subject of the supplier's advertisement. In one embodiment, this score is “1” if the advertisement discloses a supplier incentive and “0” otherwise. In another embodiment, the score reflects the type of supplier incentive, for example scaling upward with larger rebate amounts (e.g., “$2 off” would result in a higher supplier incentive score than “$1 off”).

The retailer incentive score is similar, but reflects an incentive provided by the retailer. Usually a retailer incentive will encompass a range of products including both the supplier's product and competing products. Thus, for example, a retailer may advertise “10% off all pain killers”. Again, a binary scale may be used (“1” if a retailer's incentive applies to the supplier's advertised product, otherwise “0”), or a more complex scale may be used such as: “1” if the retailer's incentive applies only to the supplier's advertised product; “0.5” if the retailer's incentive applies to all products of the type of the supplier's advertised product (e.g., “all pain killers”); and “0” otherwise.

The foregoing advertising scores set 521 are merely examples, and other metrics of the advertisement that are likely to impact its effectiveness at boosting sales of the subject product are also contemplated.

The illustrative competitors' scores set 522 includes three scores: a competing advertisements number score; a competing advertisements size score; and a competing private label score. These scores measure aspects of competing advertisements. A competing advertisement is determined based on the product class or based on other information provided by the relevant products database 40 provided to the valuation system as part (or all) of the product supplier information 42. In some applications, some or all competing products may be specifically identified in the relevant products database 40 by brand and product name. This latter approach may be of especial use if a certain competing product or group of competing products is considered particularly relevant.

The competing advertisements number score is inversely related to the number of competing advertisements, reflecting the expectation that if the circular contains more competing advertisements then the supplier's advertisement is expected to be less effective. In one suitable approach, this score is “1” if there are no competing advertisements, and is 1/CA if the number of competing advertisements (CA) is one or greater. (Thus, by way of example, if there are three competing advertisements then CA=3 and the competing advertisements number score would be ⅓=0.33). Other score quantification approaches can be employed.

The competing advertisements size score can be variously computed. In one embodiment, the score is based on the size of the largest competing advertisement. In this approach, by way of illustrative example, if the largest competing advertisement is smaller than the supplier's advertisement then this score is “1”, if they are the same size then this score is “0.5”, and if the largest competing advertisement is larger than the supplier's advertisement then this score is “0”. Other scaling may be employed. In another approach, the score is based on the total area of all competing advertisements, rather than being based only on the largest competing advertisement. In either case, if there are no competing advertisements then this score is suitably either omitted or set to a high value such as “1”.

The competing private label score reflects whether or not the advertising circular includes an advertisement for a competing product that is sold under the private label of the retailer. Such a competing advertisement is expected to be particularly devaluating since the retailer has particular incentive to encourage purchase of its own private label brand, and because the private label brand typically is sold at a lower cost as compared with “brand name” products. Accordingly, the competing private label score is selected to introduce devaluation if a competing private label advertisement is included in the circular, or conversely is selected to enhance valuation if a competing private label advertisement is not included in the circular. In an example of the former, the competing private label score may be “0” if there is no competing private label advertisement, and a negative value, e.g. “−0.5” if there is a competing private label advertisement. In an example of the latter, the competing private label score may be “1” if there is no competing private label advertisement, and may be “0” if there is a competing private label advertisement.

The illustrative competitors' scores set 522 is merely an example, and different, fewer, or more scores may be included that measure various aspects of competitor's advertisements. In some embodiments, the scores of the competitor's scores set may depend on the identity of the competing product being advertised. For example, in a product class that is dominated by competing supplier X, an advertisement by competing supplier X may be expected to produce more devaluation of the supplier's advertisement than an advertisement by some other supplier who holds a smaller market share. One way to account for this is to add a “competing supplier X score” that operates similarly to the competing private label score already described, so as to introduce additional devaluation in the event that the advertising circular contains an advertisement by competing supplier X.

The past history scores 523 reflect the effect on valuation of the current advertisement of past advertising history for the subject product. In considering the effect of past advertising history on the valuation of a current advertisement, the inventors have identified two opposing impacts. In general, past advertisements are expected to provide a reinforcing effect, in which advertisement valuation increases when there have been past advertisements. Without being limited to any particular theory of operation, it is believed that this reinforcing effect is due to enhanced brand name recognition engendered by repetitive advertisement runs over two or more weeks. Thus, a previous runs score is provided, whose value is a positive value for second or later advertisement runs. The previous runs score may be a binary score, for example having a value of “0” if the current advertisement was not preceded by an immediately preceding run (where “immediately preceding” refers to the advertisement circular distribution cycle, for example a weekly cycle in the case of a weekly newspaper advertising circular) and having a value of “1” if the current advertisement was preceded by an immediately preceding run. Alternatively, the value may depend on the number of preceding runs containing the advertisement. For example, the value may range from “0”, “0.5”, and “1” where “0.5” is used if there was only one week's preceding run and “1” is used if there were two or more weeks of preceding runs.

The inventors have also identified an opposing impact of past advertising history. In the special case in which the immediately preceding advertisement was for a bulk quantity, the impact of this past advertising can be devaluation of the current advertisement, rather than enhanced valuation. A bulk quantity advertisement is one which encourages purchase of a quantity of the product greater than one. A typical bulk quantity advertisement is “five-for-$5”, or “buy one get one free”, or so forth. Without being limited to any particular theory of operation, it is believed that a bulk quantity advertisement tends to cause consumers to stock up on the item, such that the consumer fills his or her immediate need for the item. As a consequence, an advertisement immediately following a bulk advertisement (e.g., following in next week's advertisement circular) is less likely to result in new purchases of the product, and hence has lowered valuation.

This is reflected in the illustrative past history scores 523 by inclusion of a previous bulk quantity score. In a suitable scoring scale, the previous bulk quantity score is suitably zero if there was no previous bulk quantity advertisement, and has some negative value if there was a previous bulk quantity advertisement. Thus, a previous bulk quantity advertisement penalizes the valuation of the current advertisement. Alternatively, the previous bulk quantity score can have a large positive value (e.g., “1”) if there was no previous bulk quantity advertisement and a lower positive value (e.g., “0”) if there was a previous bulk quantity advertisement. This latter scoring approach places positive value on not having had a previous bulk quantity advertisement.

The foregoing scores are computed based on the current advertising circular C (see FIG. 1). However, it is also contemplated for the scoring to account for advertising in other distribution pathways. For example, in valuating an advertisement in an advertising circular for retailer 1, the previous runs score may be increased if an advertisement for the product recently ran in an advertising circular for a different retailer 2, since this other advertisement is expected to enhance brand recognition. To employ this option (not illustrated), information about advertisements in the competing distribution pathway (e.g., for retailer 2 in the instant example) would also be needed.

With continuing reference to FIG. 2, the valuation module 502 computes the overall advertisement valuation as a weighted aggregation of the scores 521, 522, 523 generated by the scoring module 501. Denoting the total number of scores by N, and the scores as CR[1], CR[2], . . . , CR[N], and the corresponding score weights 503 as IV[1], W[2], . . . W[N], a suitable representation of the valuation is as follows:

$$V = {\sum }_{i = 1}^{N} CR [ i ] \cdot W [ i ] . \qquad ( 1 )$$

In some embodiments it may be desirable to include only some of the N scores. For example, in prospective prediction the competitors' scores 522 may be unavailable. To accommodate such cases, the valuation may be written as follows:

$$V = \frac{{\sum }_{i = 1}^{N} CR [ i ] \cdot W [ i ] \cdot I [ i ]}{{\sum }_{i = 1}^{N} I [ i ]} . \qquad ( 2 )$$

where each term I[i] has value “1” if the corresponding score CR[i] is used and has value “0” otherwise, and the denominator of the weighted aggregation of Equation (2) provides normalization so that valuations computed using different sets of scores are quantitatively comparable.

In the illustrative embodiments, the formats for scores CR[i] are chosen so that each score CR[i] is less than or equal to one. In such a case, the scores CR[i] are generally comparable in scale, and the weights are also suitably in a range of [0,1]. More generally, however, the different scores CR[1], CR[2], . . . , CR[N] can have substantially different ranges, and are not necessarily bounded by one. In such embodiments, the weights are suitably chosen such that the terms of the weighted aggregation are sufficiently comparable that the various scores can make meaningful contributions to the aggregated valuation. For example, if the score CR[1] has a range of [0, 100] and the score CR[2] has a range [0,1], then the corresponding weights W[1], W[2] may suitably have a ratio of order W[1]/W[2]˜0.01 so that the generally much smaller value of CR[2] can make a meaningful contribution to the weighted aggregation.

The values of the weights W[1], W[2], . . . W[N] are further chosen to enhance or reduce the significance of the corresponding scores CR[1], CR[2], . . . CR[N] in the weighted aggregation that defines the overall advertisement valuation. In a one embodiment, all the weights are set to unity, so that scores CR[1], CR[2], . . . , CR[N] have equal contributions (assuming the scores are bounded by unity or otherwise have comparable ranges, as previously discussed).

In other embodiments, the weights W[1], W[2], . . . , W[N] are optimized with respect to “training data” comprising advertising circulars and corresponding actual sales information. In these embodiments, the weights W[1], W[2], . . . , W[N] are chosen to obtain a substantial correlation between (1) the valuations computed for an advertisement of interest (e.g., the supplier's advertisement) in the various “training” advertisement circulars and (2) the corresponding actual sales during a time interval reasonably expected to be influenced by the advertising circular (e.g., during the week following distribution of the circular in the case of a circular that is distributed on a weekly basis). Such training can be done manually, for example by manually adjusting the weights W[1], W[2], . . . W[N] and re-calculating the valuations until a substantial correspondence is obtained. Alternatively, the training can be done in an automatic or semiautomatic fashion, for example by optimizing a figure of merit measuring correlation between the valuations and the relevant actual sales respective to optimization parameters comprising the weights W[1], W[2], . . . , W[N]. The weights W[1], W[2], . . . , W[N] may be chosen for a specific product type or class, and may be different for different product types or classes.

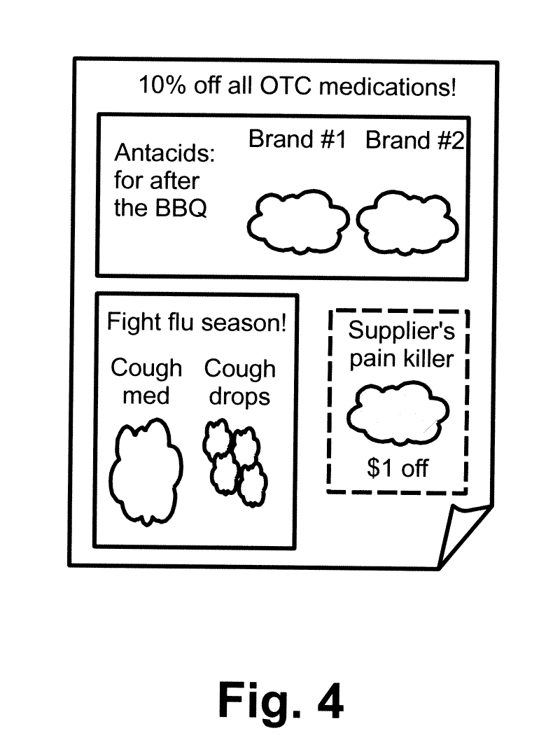

With reference to FIGS. 3 and 4, illustrative examples are provided of an advertisement having a low quantitative valuation (FIG. 3) and having a large quantitative valuation (FIG. 4). In both cases, the selected advertisement is the supplier's advertisement and is titled “Supplier's pain killer”. This advertisement advertises a product comprising a pain killer such as (for example) an aspirin product. In the case of FIG. 3, it will be noticed that: (1) the advertisement size score is low because the “Supplier's pain killer” advertisement is small; (2) the incentive scores are low or zero since there is no incentive associated with the “Supplier's pain killer” advertisement; (3) the competing advertisement number score is low because there are three competing pain killer advertisements; and (4) the competing advertisement size score is low because the largest competing advertisement is larger in size than the “Supplier's pain killer” advertisement (or, in the alternative embodiment in which this score measures the total size of all competing advertisements, the total area of the three competing advertisements is larger in size than the “Supplier's pain killer” advertisement). Accordingly, the valuation computed as the weighted aggregation of these scores is also expected to be low.

By contrast, in the example of FIG. 4, it will be noticed that: (1) the advertisement size score is at least relatively high because the “Supplier's pain killer” advertisement is relatively large; (2) the supplier incentive score is high since the “Supplier's pain killer” advertisement has an associated supplier incentive (“$1 off”); (3) the retailer incentive score is high since the “Supplier's pain killer” advertisement has an associated retailer incentive “10% off all OTC medications!”); and (4) the competing advertisement number and size scores are low or zero because there are no competing pain killer advertisements. Accordingly, the valuation computed as the weighted aggregation of these scores is expected to be high in the case of FIG. 4.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

1. A method comprising:
computing a plurality of scores measuring aspects of an advertisement included in a printed advertising circular; and
computing a quantitative valuation of the advertisement by computing a weighted aggregation of the scores;
wherein at least the computing of the weighted aggregation is performed by a digital processing device.

2. The method as set forth in claim 1, wherein the computing of a plurality of scores comprises:
computing an advertisement score quantifying a size of the advertisement.

3. The method as set forth in claim 1, wherein the computing of a plurality of scores comprises:
computing an incentive score indicative of whether the advertisement has an associated incentive.

4. The method as set forth in claim 1, wherein the computing of a plurality of scores comprises:
computing at least one competition score measuring an aspect of competing advertisements also included in the printed advertising circular.

5. The method as set forth in claim 4, wherein the computing of at least one competition score comprises:
computing a competing advertisement number score indicative of a number of competing advertisements included in the printed advertising circular.

6. The method as set forth in claim 4, wherein the computing of at least one competition score comprises:
computing a competing advertisement size score indicative of a size of a largest competing advertisement.

7. The method as set forth in claim 4, wherein the computing of at least one competition score comprises:
computing a competing advertisement size score indicative of a total size of competing advertisements.

8. The method as set h in claim 4, wherein the computing of at least one competition score comprises:
computing at least one competition score whose value depends on a brand of a competing advertisement.

9. The method as set forth in claim 8, wherein the computing of at least one competition score whose value depends on a brand of a competing advertisement comprises:
computing a private label score whose value depends on whether a competing advertisement has a private label brand corresponding to a retailer that produced the printed advertising circular.

10. The method as set forth in claim 1, wherein the computing of a plurality of scores comprises:
computing at least one past history score selected to adjust the quantitative valuation based on past advertising history of a product advertised by the advertisement.

11. The method as set forth in claim 10, wherein the computing of at least one past history score comprises:
computing a previous runs score for which a relatively lower value corresponds to no recent past advertising history and a relatively higher value corresponds to recent past advertising history.

12. The method as set forth in claim 10, wherein the computing of at least one past history score comprises:
computing a previous bulk quantity score for which a relatively lower value corresponds to recent bulk quantity advertisement history and a relatively higher value corresponds to no recent bulk quantity advertisement history.

13. The method as set forth in claim 1, wherein the computing a quantitative valuation of the advertisement by computing a weighted aggregation of the scores comprises:
setting one or more weights of one or more corresponding scores to zero in order to exclude the one or more corresponding scores from the quantitative valuation.

14. The method as set forth in claim 1, wherein the computing a quantitative valuation of the advertisement by computing a weighted aggregation of the scores comprises:
computing the weighted aggregation of the scores; and
binning the weighted aggregation of the scores to generate a semantically meaningful quantitative valuation.

15. The method as set forth in claim 1, further comprising:
repeating the computing of a plurality of scores and the computing of a quantitative valuation for printed advertising circulars of a plurality of different circular distribution dates; and
generating a plot of the quantitative valuations as a function of circular distribution date.

16. The method as set forth in claim 1, further comprising:
adjusting at least one of the computed scores to optimize the quantitative valuation of the advertisement.

17. The method as set forth in claim 1, further comprising:
segmenting the advertising circular to identify advertisements of the advertising circular; and
generating a layout of advertisements of the advertisement circular, the generated layout being used in the computing of a plurality of scores;
wherein the segmenting and the generating of the layout are also performed by the digital processing device.

18. An apparatus comprising:
a digital processing device configured to perform a method comprising computing a plurality of scores measuring aspects of an advertisement included in a printed advertising circular and computing a quantitative valuation of the advertisement by computing a weighted aggregation of the scores; and
a display device for displaying a visual representation of the quantitative valuation.

19. The apparatus as set forth in claim 18, further comprising:
an optical scanner configured to optically scan the printed advertising circular to generate page images, wherein the digital processing device is further configured to segment the page images to identify individual advertisements of the advertising circular and to generate a layout of the individual advertisements in the advertising circular that is used in computing at least one of the scores.

20. The apparatus as set forth in claim 19, wherein the digital processing device is further configured to perform optical character recognition (OCR) on the individual advertisements to extract text information for the individual advertisements indicative of at least brand and product class or type, the extracted text information being used in computing at least one of the scores.

21. A storage medium storing instructions executable by a digital processor to perform a method including (i) computing a plurality of scores measuring aspects of an advertisement included in a printed advertising circular and (ii) computing a quantitative valuation of the advertisement by computing a weighted aggregation of the scores.

22. The storage medium as set forth in claim 21, wherein the computing of a plurality of scores includes computing an advertisement score quantifying a size of the advertisement.

23. The storage medium as set forth in claim 21, wherein the computing of a plurality of scores includes computing a competing advertisement number score measuring a number of competing advertisements also included in the printed advertising circular.

24. The storage medium as set forth in claim 21, wherein the computing of a plurality of scores includes computing a competing advertisement size score measuring a size of one of (I) a largest competing advertisement also included in the printed advertising circular and (II) one or more competing advertisements also included in the printed advertising circular.

25. The storage medium as set forth in claim 21, wherein the computing of a plurality of scores includes computing at least one score whose value depends on a brand of a competing advertisement also included in the printed advertising circular.

26. The storage medium as set forth in claim 21, wherein the computing of a plurality of scores includes computing a previous runs score for which a relatively lower value corresponds to no recent past advertising history for a product advertised in the advertisement and a relatively higher value corresponds to recent past advertising history for the product advertised in the advertisement.

27. The storage medium as set forth in claim 21, wherein the computing of a plurality of scores includes computing a previous bulk quantity score for which a relatively lower value corresponds to recent bulk quantity advertising history for a product advertised in the advertisement and a relatively higher value corresponds to no recent bulk quantity advertising history for the product advertised in the advertisement.

28. The storage medium as set forth in claim 21, wherein the computing a quantitative valuation of the advertisement by computing a weighted aggregation of the scores comprises binning the weighted aggregation of the scores to convert the weighted aggregation to a semantically meaningful quantitative valuation.
